(19) United States
(12) Patent Application Publication
(10) Pub. No.: US 2026/0010986 A1
(43) Pub. Date: Jan. 8, 2026

(54) METHODS AND ELECTRONIC APPARATUS FOR GRID PATTERN NOISE DETECTION

(71) Applicant: SAMSUNG ELECTRONICS CO., LTD., Suwon-si (KR)

(72) Inventors: Sudarshan RAMENAHALLI GOVINDARAJU, Bengaluru (IN); Rahul VARNA, Bengaluru (IN)

(73) Assignee: SAMSUNG ELECTRONICS CO., LTD., Suwon-si (KR)

(21) Appl. No.: 19/265,365

(22) Filed: Jul. 10, 2025

Related U.S. Application Data
(63) Continuation of application No. PCT/IB2025/055547, filed on May 29, 2025.

(30) Foreign Application Priority Data
May 29, 2024 (IN) 202441041767
Nov. 4, 2024 (IN) 202441041767

(51) Int. Cl. G06T 5/70; G06T 5/10; G06T 5/60; G06T 7/90

(52) U.S. Cl. CPC G06T 5/70; G06T 5/10; G06T 5/60; G06T 7/90; G06T 2207/10024; G06T 2207/20056; G06T 2207/20081; G06T 2207/20084

(57) ABSTRACT

A method for detecting grid pattern noise in an image, the method comprising: obtaining the image; determining a spectrum map of at least one color channel of the image; detecting an occurrence of periodic peaks in the spectrum map; determining a distance between a set of adjacent peaks based on a location of the periodic peaks in the spectrum map; detecting a presence of grid pattern noise in the image based on the distance; and eliminating, based on the detecting of the presence of the grid pattern noise, the grid pattern noise from the image, resulting in a revised image.

### CROSS-REFERENCE TO RELATED APPLICATIONS

This application is a continuation application of International Application No. PCT/IB2025/055547, filed on May 29, 2025, which claims priority to Indian Provisional Patent Application No. 202441041767, filed on May 29, 2024, and Indian Patent Application No. 202441041767, filed on Nov. 4, 2024, in the Indian Intellectual Property Office, the disclosures of which are incorporated by reference herein in their entireties.

### BACKGROUND

### 1. Field

The present disclosure relates generally to image processing, and more particularly to, methods, apparatuses, and systems for detecting and/or eliminating grid pattern noise from an image captured using a user device.

### 2. Description of Related Art

Advancements in technology may have transformed mobile devices (e.g., smartphones, cellular phones, tablet computers, laptop computers, or the like) into relatively powerful imaging devices, that may even be used by professionals (e.g. photographers). Attempts to meet a growing demand for high-quality images may result in upgrades to the mobile devices. For example, the upgrades may include, but not be limited to, integrating, into the mobile devices, improved and/or additional camera sensors that may be capable of capturing relatively high-resolution pictures.

However, due to hardware limitations of the camera sensors, grid pattern noise may be introduced in high-resolution images captured using the camera sensors. For example, the grid pattern noise may be visible when a high-resolution image is captured with bright light in the background. Alternatively or additionally, grid pattern noise may also occur in scenarios other than the bright light. The grid pattern noise, which may also be referred to as block pattern noise, may refer to a type of image noise that may appear as a repeating pattern of square and/or rectangular shapes. Further, the grid pattern noise may be a distinct interference pattern that may be characterized by periodic, high-frequency, grid-like noise superimposed on the image, as illustrated in FIGS. 1A and 1B.

FIGS. 1A and 1B are pictorial diagrams 100-1 and 100-2 depicting exemplary grid pattern noise in high-resolution images. FIG. 1A depicts a high-resolution image 101 of trees captured in bright sunlight. As shown in FIG. 1A, when section 103 of image 101 is zoomed-in, grid-like patterns may become visible on a tree within the enlarged section 105. As another example, FIG. 1B depicts another high-resolution image 107 of buildings during bright sunlight. As shown in FIG. 1B, when section 109 of image 107 is zoomed-in, grid-like patterns may become visible on a building within the enlarged section 111.

As described above, a grid-like noise pattern may be visible in the vicinity of the light source in an image that may lead to degradation of image quality. Further, eliminating the grid-like noise pattern may be challenging since data acquisition for addressing the issue may be costly, may involve relatively complex technical details, and may be time-consuming.

Accordingly, there is a need to overcome the above-described limitations. Additionally, there is a need to provide a methodology for detecting and/or eliminating grid pattern noise from images captured using high-resolution camera sensors.

### SUMMARY

This summary is provided to introduce a selection of concepts, in a simplified format, that are further described in the detailed description of the present disclosure. This summary is neither intended to identify key or essential inventive concepts of the present disclosure nor is it intended for determining the scope of the present disclosure.

According to an aspect of the present disclosure, a method for detecting grid pattern noise in an image, the method comprising: obtaining the image; determining a spectrum map of at least one color channel of the image; detecting an occurrence of periodic peaks in the spectrum map; determining a distance between a set of adjacent peaks based on a location of the periodic peaks in the spectrum map; detecting a presence of grid pattern noise in the image based on the distance; and eliminating, based on the detecting of the presence of the grid pattern noise, the grid pattern noise from the image, resulting in a revised image.

The detecting of the occurrence of the periodic peaks may include detecting a plurality of peaks in the spectrum map; and detecting the occurrence of the periodic peaks based on a periodicity of the plurality of peaks in the spectrum map.

The detecting of the occurrence of the periodic peaks further may include obtaining position information corresponding to the plurality of peaks in the spectrum map; and detecting the occurrence of the periodic peaks based on the position information.

The detecting of the occurrence of the periodic peaks may include detecting a first peak and a second peak in the spectrum map, wherein the determining of the distance between the set of adjacent peaks may include obtaining a first position of the first peak and a second position of the second peak; and determining the distance between the set of adjacent peaks based on the first position of the first peak and the second position of the second peak, and wherein the detecting of the presence of the grid pattern noise may include detecting the presence of the grid pattern noise in the image based on the distance exceeding a predetermined threshold.

The detecting of the occurrence of the periodic peaks may include detecting a first peak, a second peak, and a third peak in the spectrum map; obtaining a first position of the first peak, a second position of the second peak, and a third position of the third peak; obtaining a first distance between the first position of the first peak and the second position of the second peak; obtaining a second distance between the second position of the second peak and the third position of the third peak; obtaining a difference between the first distance and the second distance; and identifying, based on the difference being smaller than a predetermined value, the occurrence of the periodic peaks in the spectrum map.

The obtaining of the image may include obtaining the image from a camera of a user device.

The spectrum map may include a Fourier magnitude spectrum map.

The image may include red, green, and blue (RGB) image data, and wherein the RGB image data may include the at least one color channel.

The method may include determining an inverse spectrum map corresponding to the spectrum map of the at least one color channel; and extracting the grid pattern noise from the image using the inverse spectrum map.

The method may include providing the grid pattern noise and the image as input to a trained artificial intelligence (AI) model; and generating a grid pattern free image by eliminating the grid pattern noise from the image using the trained AI model.

According to an aspect of the present disclosure, an electronic apparatus for detecting grid pattern noise in an image, the electronic apparatus comprising: one or more processors comprising processing circuitry; and memory storing instructions, wherein the instructions, when executed by the one or more processors individually or collectively, cause the electronic apparatus to obtain the image; determine a spectrum map of at least one color channel of the image; detect an occurrence of periodic peaks in the spectrum map; determine a distance between a set of adjacent peaks based on a location of the periodic peaks in the spectrum map; detect a presence of grid pattern noise in the image based on the distance; and eliminate, based on the detection of the presence of the grid pattern noise, the grid pattern noise from the image, resulting in a revised image.

The instructions, when executed by the one or more processors individually or collectively, further cause the electronic apparatus to detect a plurality of peaks in the spectrum map; and detect the occurrence of the periodic peaks based on a periodicity of the plurality of peaks in the spectrum map.

The instructions, when executed by the one or more processors individually or collectively, further cause the electronic apparatus to obtain position information corresponding to the plurality of peaks in the spectrum map; and detect the occurrence of the periodic peaks based on the position information.

The instructions, when executed by the one or more processors individually or collectively, further cause the electronic apparatus to: detect a first peak and a second peak in the spectrum map; obtain a first position of the first peak and a second position of the second peak; determine the distance between the set of adjacent peaks based on the first position of the first peak and the second position of the second peak; and detect, based on the distance exceeding a predetermined threshold, the presence of grid pattern noise in the image.

The instructions, when executed by the one or more processors individually or collectively, further cause the electronic apparatus to: detect a first peak, a second peak, and a third peak in the spectrum map; obtain a first position of the first peak, a second position of the second peak, and a third position of the third peak; obtain a first distance between the first position of the first peak and the second position of the second peak; obtain a second distance between the second position of the second peak and the third position of the third peak; obtain a difference between the first distance and the second distance; and identify, based on the difference being smaller than a predetermined value, the occurrence of the periodic peaks in the spectrum map.

The spectrum map may include a Fourier magnitude spectrum map.

The image may include red, green, and blue (RGB) image data, and wherein the RGB image data may include the at least one color channel.

The instructions, when executed by the one or more processors individually or collectively, further cause the electronic apparatus to: determine an inverse spectrum map corresponding to the spectrum map of the at least one color channel; and extract the grid pattern noise from the image using the inverse spectrum map.

The instructions, when executed by the one or more processors individually or collectively, further cause the electronic apparatus to: provide the grid pattern noise and the image as input to a trained artificial intelligence (AI) model; and generate a grid pattern free image by eliminating the grid pattern noise from the image using the trained AI model.

According to an aspect of the present disclosure, a method for detecting grid pattern noise in an image captured using a user device includes obtaining the image captured using a camera of the user device, determining a Fourier magnitude spectrum map of at least one color channel of RGB image data of the captured image, detecting occurrence of periodic peaks in the Fourier magnitude spectrum map, and detecting presence of grid pattern noise in the captured image when the distance between the set of adjacent peaks exceeds a predetermined threshold associated with determination of grid pattern.

According to an aspect of the present disclosure, a method for eliminating grid pattern noise from an image captured using a user device includes obtaining the image captured using a camera of the user device, detecting presence of grid pattern noise in the captured image corresponding to periodic peaks in a Fourier magnitude spectrum map of the captured image, extracting the grid pattern noise from the captured image and generating a grid pattern free image by eliminating the extracted grid pattern noise from the captured image using a trained AI model.

According to an aspect of the present disclosure, a system for detecting grid pattern noise in an image captured using a user device includes a memory and a processor coupled with the memory. The processor is configured to obtain the image captured using a camera of the user device, determine a Fourier magnitude spectrum map of at least one color channel of RGB image data of the captured image, determine a distance between a set of adjacent peaks based on a location of the periodic peaks in the Fourier magnitude spectrum map, and detect presence of grid pattern noise in the captured image when the distance between the set of adjacent peaks exceeds a predetermined threshold associated with determination of grid pattern.

According to an aspect of the present disclosure, a system for eliminating grid pattern noise from an image captured using a user device includes a memory and a processor coupled with the memory. The processor is configured to obtain the image captured using a camera of the user device, detect presence of grid pattern noise in the captured image corresponding to periodic peaks in a Fourier magnitude spectrum map of the captured image, extract the grid pattern noise from the captured image, and generate a grid pattern free image by eliminating the extracted grid pattern noise from the captured image using a trained AI model.

To further clarify the advantages and features of the present disclosure, a more particular description of the present disclosure is rendered by reference to specific embodiments thereof, which is illustrated in the accompanying drawings. It is to be apparent that these drawings depict only typical embodiments of the present disclosure and are not to be considered limiting its scope. The present disclosure is described and explained with additional specificity with the accompanying drawings.

### BRIEF DESCRIPTION OF THE DRAWINGS

The foregoing and other features of embodiments may be more apparent from the following description when taken in conjunction with the accompanying drawings, in which:

FIGS. 1A and 1B are pictorial diagrams depicting exemplary grid pattern noise in high-resolution images, according to embodiments of the present disclosure;

FIG. 2 is a block diagram depicting a user device implementing a system detecting and/or eliminating grid pattern noise from images captured using the user device, according to embodiments of the present disclosure;

FIG. 3A is a block diagram depicting the plurality of modules for detecting and/or eliminating grid pattern noise from images captured using the user device, according to embodiments of the present disclosure;

FIG. 3B is a block diagram depicting an exemplary operational pipeline of a first subset of the plurality of modules in a first predetermined sequence, according to embodiments of the present disclosure;

FIG. 3C is a block diagram depicting an exemplary operational pipeline of a second subset of the plurality of modules in a second predetermined sequence, according to embodiments of the present disclosure;

FIG. 4 is a block diagram depicting an operational flow of the grid pattern detection module and grid pattern extraction module, according to the embodiments of the present disclosure;

FIG. 5 is a block diagram depicting operational flow for determining the plurality of peaks, according to embodiments of the present disclosure;

FIG. 6 is a pictorial diagram depicting exemplary visualization of extracted patterns, according to embodiments of the present disclosure;

FIG. 7 is a block diagram depicting an operational flow of the blending module, for determination of the optimized blending factor, according to embodiments of the present disclosure;

FIG. 8 is a pictorial diagram depicting exemplary clean image, blended grid pattern noisy image, and clean ground truth image, according to embodiments of the present disclosure;

FIG. 9 is a pictorial diagram depicting an exemplary grid pattern free image generated by the trained AI model, according to embodiments of the present disclosure;

FIG. 10 is a flow diagram depicting a method for detecting the grid pattern in the image captured using the user device, according to embodiments of the present disclosure;

FIG. 11 is a flow diagram depicting a method for eliminating the grid pattern from the image captured using the user device, according to embodiments of the present disclosure; and

FIG. 12 is a pictorial diagram depicting a use case illustrating elimination of grid pattern from an image captured using the user device, according to embodiments of the present disclosure.

### DETAILED DESCRIPTION

In order to provide an understanding of the principles of the present disclosure, reference is made to various embodiments and specific language is used to describe the same. It is to be understood that no limitation of the scope of the present disclosure is thereby intended, such that alterations and further modifications in the illustrated system may be made without departing from the scope and spirit of the disclosure. In addition, further applications of the principles of the present disclosure as illustrated therein contemplated as would normally occur to one skilled in the art also relate to the present disclosure.

It is to be understood by those skilled in the art that the foregoing general description and the following detailed description are explanatory of the present disclosure and are not intended to be restrictive thereof.

Further, skilled artisans may appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that may be readily apparent to those of ordinary skill in the art having the benefit of the description herein.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It may be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore may not necessarily be taken as limiting factors to the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” may not, without more constraints, preclude the existence of other devices or other sub-systems or other elements or other structures or other components or additional devices or additional sub-systems or additional elements or additional structures or additional components.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

A methodology is described in the following paragraphs of the disclosure.

The present disclosure address the above-described limitations associated with grid pattern noise in images captured using high-resolution camera sensors.

The present disclosure provides a methodology for detecting and/or eliminating grid pattern noise from images captured using high-resolution camera sensors without modifying or tuning the camera sensor hardware. The provided methodology utilizes a trained artificial intelligence (AI) model for generating grid pattern free images. According to the embodiments of the present disclosure, the AI model may be trained and fine-tuned by synthetically creating a training dataset for the AI model.

Hereinafter, various embodiments of the present disclosure are be described with reference to the accompanying drawings.

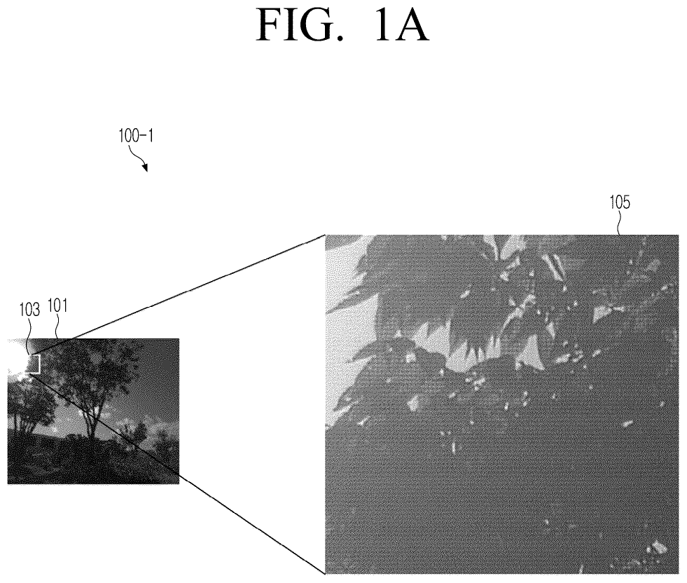

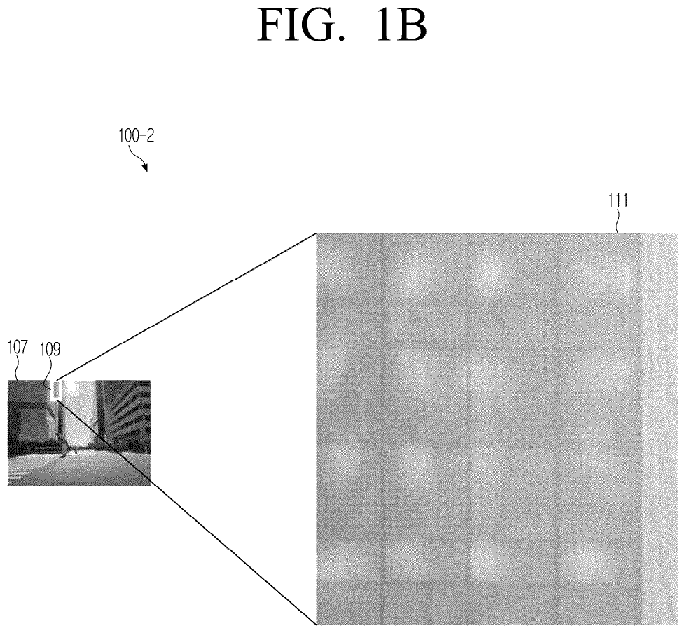

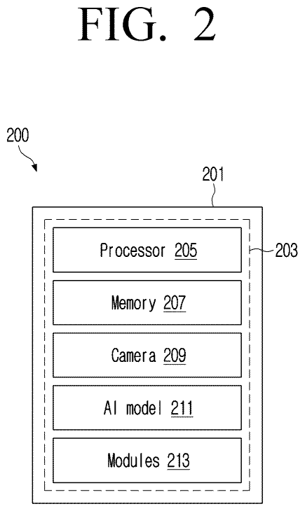

For the sake of clarity, the first digit of a reference numeral of each component of the present disclosure is indicative of the figure number, in which the corresponding component is shown. For example, reference numerals starting with digit “1” are shown at least in FIG. 1. Similarly, reference numerals starting with digit “2” are shown at least in FIG. 2.

FIG. 2 is a block diagram 200 depicting a user device 201 implementing a system 203 for detecting and/or eliminating grid pattern noise from images captured using the user device 201, according to embodiments of the present disclosure. The user device 201 may correspond to any smart device equipped with high-resolution camera sensors, for example, the user device 201 may include, but not be limited to a smartphone, digital single-lens reflex (DSLR) camera, or the like.

According to embodiments of the present disclosure, the system 203 may be implemented for detecting grid pattern noise in an image captured using the user device 201. According to embodiments of the present disclosure, the system 203 may be further implemented for eliminating grid pattern noise from the image captured using a user device 201. The system may include a processor 205, a memory 207, a camera 209, an AI model 211, and a plurality of modules 213.

In an example, the processor 205 may be a single processing unit or a number of units, all of which may include multiple computing units. The processor 205 may be implemented as one or more microprocessors, microcomputers, microcontrollers, digital signal processors (DSPs), central processing units (CPUs), logical processors, virtual processors, state machines, logic circuitries, and/or any devices that manipulate signals based on operational instructions. Among other capabilities, the processor 205 may be configured to fetch and execute computer-readable instructions and data stored in the memory 207.

The memory 207 may include a non-transitory computer-readable medium such as, for example, volatile memory or random access memory (RAM), such as, but not limited to, static random access memory (SRAM) and dynamic random access memory (DRAM), and/or non-volatile memory, such as, but not limited to, read-only memory (ROM), erasable programmable ROM, flash memories, hard disks, optical disks, magnetic tapes, or the like.

At least one of a plurality of operations of the system 203 may be implemented through the AI model 211. A function associated with AI may be performed through the non-volatile memory, the volatile memory, and the processor 205.

The processor 205 may include one processor or a plurality of processors. In an embodiment, the one processor or the plurality of processors may be and/or may include a general purpose processor (e.g., a CPU, an application processor (AP), or the like), a graphics-only processing unit (e.g., a graphics processing unit (GPU), a visual processing unit (VPU), or the like), and/or an AI-dedicated processor (e.g., a neural processing unit (NPU)).

The one processor or the plurality of processors may control the processing of the input data in accordance with a predefined operating rule and/or AI model stored in the non-volatile memory and/or the volatile memory. The predefined operating rule or artificial intelligence model may be provided through training and/or learning.

As used herein, being provided through learning may refer to applying a learning technique to a plurality of learning data, a predefined operating rule, and/or AI model of a desired characteristic is made. The learning may be performed in the user device 201 in which AI, according to an embodiment, is performed, and/or may be implemented through a separate server/system.

In an embodiment, the camera 209 may include at least one high-resolution camera sensor capable of capturing high-quality, high dynamic range (HDR) images. In an embodiment, the camera 209 may be capable of capturing images in 200 megapixels (MP), 24 MP, or 50 MP. However, the present disclosure is not limited in this regard, the camera 209 may capture images in other resolutions.

According to embodiments of the present disclosure, the AI model 211 may refer to a predetermined machine learning-based model for denoising images. The AI model 211 may be trained, according to embodiments of the present disclosure. In an embodiment, the AI model 211 may be trained on the user device 201. In an embodiment, the AI model 211 may be trained on a cloud environment (e.g., a cloud server) and thereafter may be stored in the user device 201.

The AI model 211 may include a plurality of neural network layers. Each layer may have a plurality of weight values and may perform a layer operation through the calculation of a previous layer and an operation of a plurality of weights. Examples of neural networks may include, but not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), deep Q-networks, or the like.

The learning technique may be a method for training a predetermined target device (e.g., a robot) using a plurality of learning data to cause, allow, or control the target device to decide or predict. Examples of learning techniques may include, but not limited to, supervised learning, unsupervised learning, semi-supervised learning, reinforcement learning, or the like.

As mentioned above, the AI model 211 may be obtained by training. As used herein, obtained by training may refer to a predefined operation rule or artificial intelligence model configured to perform a desired feature obtained by training a basic AI model with multiple pieces of training dataset by a training technique. The AI model may include a plurality of neural network layers. Each of the plurality of neural network layers may include a plurality of weight values and may perform a neural network computation by computation between a result of a computation by a previous layer and the plurality of weight values.

In an embodiment, the plurality of modules 213 may include a program, a subroutine, a portion of a program, a software component, or a hardware component capable of performing a stated task or function. As used herein, the plurality of modules 213 may be implemented on a hardware component (e.g., a server) independently of other modules 213, or a module may exist with other modules 213 on the same server, or within the same program. The plurality of modules 213 may be implemented on a hardware component, such as, but not limited to, one or more microprocessors, microcomputers, microcontrollers, digital signal processors, central processing units, state machines, logic circuitries, and/or any devices that manipulate signals based on operational instructions. The plurality of modules 213 when executed by the processors 205 may be configured to perform any of the functionalities discussed herein. In an embodiment, a subset of the plurality of modules 213 may be implemented within the user device 201, while another subset of the plurality of modules 213 may be implemented remotely for training the AI model 211. In another embodiment, the plurality of modules 213 may be implemented on the user device 201.

In an embodiment, the plurality of modules 213 may be implemented using the AI model 211 which may include a plurality of neural network layers. Examples of neural networks may include, but not limited to, CNN, DNN, RNN, RBM, or the like. Further, learning may refer to a method for training a predetermined target device (e.g., a robot) using a plurality of learning data to cause, allow, or control the target device to make a determination or prediction. Examples of learning techniques may include, but not limited to, supervised learning, unsupervised learning, semi-supervised learning, reinforcement learning, or the like. At least one of a plurality of CNN, DNN, RNN, RBM models or the like may be implemented to thereby achieve execution of the present subject matter's mechanism through an AI model.

A function associated with an AI module may be performed through the non-volatile memory, the volatile memory, and the processor. The processor may include one or a plurality of processors. In an embodiment, the processor or the plurality of processors may be and/or may include, but not be limited to, a general-purpose processor (e.g., a CPU, an AP, or the like), a graphics-only processing unit (e.g., a GPU, a VPU, or the like), and/or an AI-dedicated processor (e.g., an NPU). The processor or the plurality of processors may control the processing of the input data in accordance with a predefined operating rule and/or AI model stored in the non-volatile memory and/or the volatile memory. The predefined operating rule and/or artificial intelligence model may be provided through training and/or learning.

The plurality of modules 213 may include a set of instructions that may be executed, according to the embodiments of the present disclosure, to detect and/or eliminate grid pattern noise from images captured using the user device 201. The plurality of modules 213 are described in the forthcoming paragraphs.

In an example, the user device 201 may be described as the electronic apparatus. The user device 201 may obtain the image, determine a spectrum map of at least one color channel of the image, detect an occurrence of periodic peaks in the spectrum map, determine a distance between a set of adjacent peaks based on a location of the periodic peaks in the spectrum map, detect a presence of grid pattern noise in the image based on the distance, and eliminate, based on the detection of the presence of the grid pattern noise, the grid pattern noise from the image, resulting in a revised image.

In another example, the user device 201 may be different from the electronic apparatus. the user device 201 may obtain the image through the camera 209. The user device 201 may transmit the image to the electronic apparatus. The electronic apparatus may implement a system for detecting and/or eliminating grid pattern noise from images.

The electronic apparatus may determine a spectrum map of at least one color channel of the image, detect an occurrence of periodic peaks in the spectrum map, determine a distance between a set of adjacent peaks based on a location of the periodic peaks in the spectrum map, detect a presence of grid pattern noise in the image based on the distance, and eliminate, based on the detection of the presence of the grid pattern noise, the grid pattern noise from the image, resulting in a revised image.

A system for detecting grid pattern noise in an image includes a user device comprising a camera configured to capture the image; and an electronic apparatus including one or more processors comprising processing circuitry, and memory storing instructions. The instructions, when executed by the one or more processors individually or collectively, cause the electronic apparatus to obtain the image captured by the camera, determine a Fourier spectrum map of at least one color channel of the image, detect an occurrence of periodic peaks in the Fourier spectrum map, determine a distance between a set of adjacent peaks based on a location of the periodic peaks in the Fourier spectrum map, detect a presence of grid pattern noise in the image based on the distance, eliminate, based on the detecting of the presence of the grid pattern noise, the grid pattern noise from the image, resulting in a revised image, and provide the revised image to the user device.

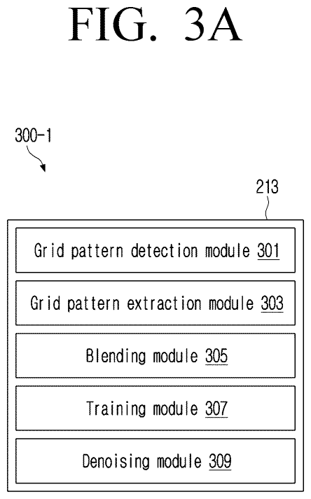

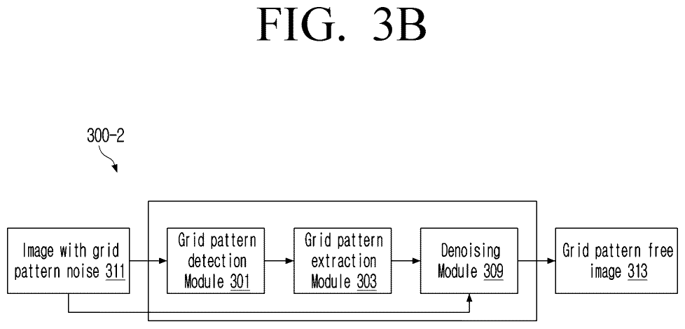

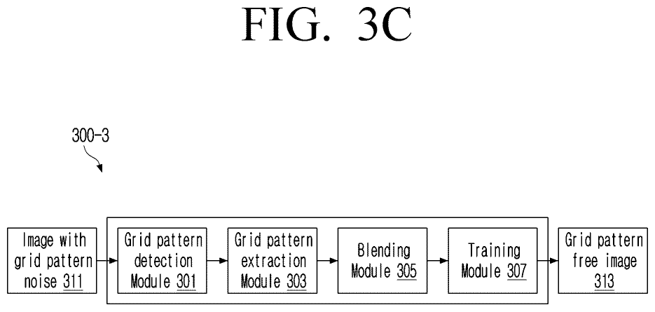

FIG. 3A is a block diagram 300-1 depicting the plurality of modules 213 for detecting and/or eliminating grid pattern noise from images captured using the user device 201, according to embodiments of the present disclosure.

As shown in FIG. 3A, the plurality of modules 213 may include a grid pattern detection module 301, a grid pattern extraction module 303, a blending module 305, a training module 307, and a denoising module 309. Further, subsets of the plurality of modules 213 may be implemented in one or more predetermined sequences, according to embodiments of the present disclosure.

FIG. 3B is a block diagram 300-2 depicting an exemplary operational pipeline of a first subset of the plurality of modules 213 in a first predetermined sequence, according to embodiments of the present disclosure. In an embodiment, the first subset of the plurality of modules 213 may include the grid pattern detection module 301, the grid pattern extraction module 303, and the denoising module 309. According to embodiments of the present disclosure, the first subset of the plurality of modules 213 may be implemented in real-time in the first predetermined sequence for detecting and/or eliminating grid pattern noise from a captured image 311 captured using the camera 209. In an example, the operational pipeline may yield a grid pattern free images 313.

FIG. 3C is a block diagram 300-3 depicting an exemplary operational pipeline of a second subset of the plurality of modules 213 in a second predetermined sequence, according to embodiments of the present disclosure. In an embodiment, the second subset of the plurality of modules 213 may include the grid pattern detection module 301, the grid pattern extraction module 303, the blending module 305, and the training module 307. According to embodiments of the present disclosure, the first subset of the plurality of modules 213 may be implemented in the second predetermined sequence to train the AI model 211 on eliminating grid pattern noise from the captured image 311 captured using the camera 209. In an example, the second operational pipeline may yield a trained AI model 211 that may be capable of generating grid pattern free images 313.

Referring back to FIG. 3A, in an embodiment, the grid pattern detection module 301 may be configured to obtain the captured image 311 captured using the camera 209 of the user device 201. In an example, the captured image 311 may have been captured in bright light, and, due to hardware limitations of the camera 209, may exhibit grid pattern noise along with other kinds of noise.

According to embodiments of the present disclosure, the grid pattern detection module 301 may be configured to compute a Fourier magnitude spectrum map of at least one color channel of red, green, and blue (RGB) image data of the captured image 311. In an example, the Fourier magnitude spectrum map may refer to the corresponding magnitude spectrum of each channel in a discrete Fourier transform (DFT) map that may include complex numbered values of individual red (R), green (G), and blue (B) channels of the captured image 311. In an alternative embodiment, the grid pattern detection module 301 may be applied to other image formats that may be capable of capturing the spatial variation of intensity pattern.

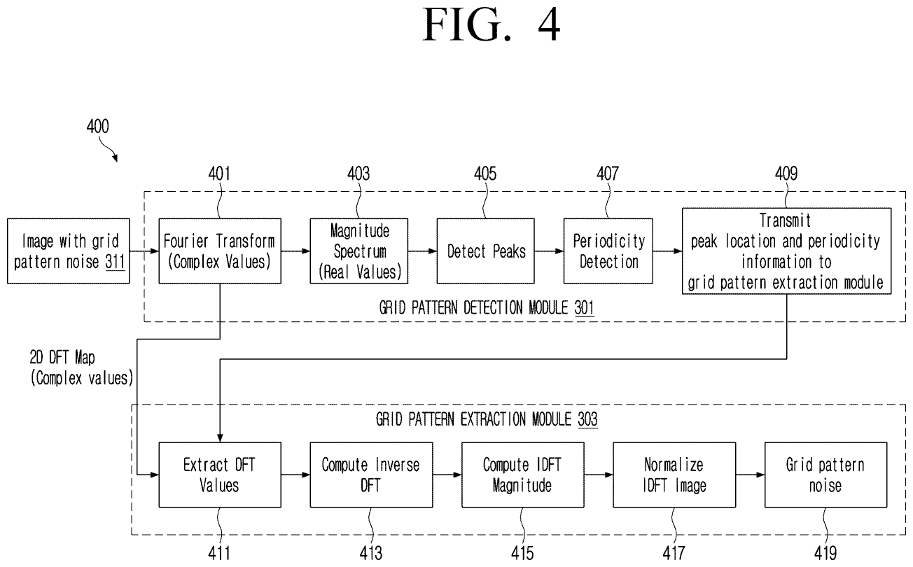

The grid pattern detection module 301 may be configured to detect a plurality of peaks in the Fourier magnitude spectrum map and detect the occurrence of the periodic peaks based on a periodicity of the plurality of peaks in the Fourier magnitude spectrum map. For example, the grid pattern detection module 301 may be configured to determine a distance between a set of adjacent peaks based on the location of the periodic peaks in the Fourier magnitude spectrum map and detect the presence of grid pattern noise in the captured image 311 when the distance between the set of adjacent peaks exceeds a predetermined threshold associated with the determination of grid pattern. The above-mentioned configuration automates the process of grid pattern noise detection without manual intervention. The grid pattern detection module 301 is described with reference to FIG. 4.

The peak may be described as a point, a pattern, and/or a feature. In a Fourier magnitude spectrum map, the peak may refer to a point where the magnitude of a particular frequency component may be significantly higher than its surrounding values. That is, the peak may be indicated as a bright spot in the spectrum map. The peak may represent a frequency where a strong signal component exists.

For example, a low-frequency peak may be located at the center of the Fourier magnitude spectrum map. When an image contains large structures (e.g., smooth gradients, broad shapes, or uniform areas), the low-frequency peak (e.g., central bright spot) may become stronger and/or larger. As another example, a high-frequency peak may be located toward the edges of the Fourier magnitude spectrum map. When an image contains more edges, textures, or fine details, the high-frequency peaks may become stronger and/or brighter.

According to embodiments of the present disclosure, the grid pattern extraction module 303 may be configured to extract the grid pattern noise from the captured image 311. In an embodiment, the grid pattern extraction module 303 may be configured to remove all frequencies except the frequencies associated with peak locations corresponding to grid pattern noise from the Fourier magnitude spectrum map. According to embodiments of the present disclosure, the grid pattern extraction module 303 may determine an inverse Fourier magnitude spectrum map corresponding to the Fourier magnitude spectrum map of the at least one color channel of the RGB image data of the captured image, and use the inverse Fourier magnitude spectrum map to extract the grid pattern noise from the captured image 311. The grid pattern extraction module 303 is described with reference to FIG. 4.

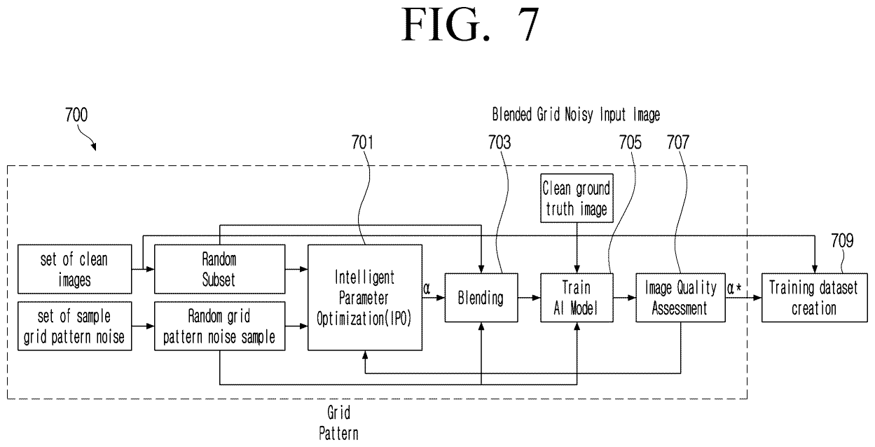

According to embodiments of the present disclosure, the blending module 305 may be implemented during training of the AI model 211. In an embodiment, during the training, the blending module 305 may be implemented after the grid pattern extraction module 303. According to embodiments of the present disclosure, the blending module 305 may be configured to generate a blended grid pattern noisy image by applying an optimized blending factor to a subset of the first set of clean images and at least one grid pattern noise sample from the first set of sample grid pattern noise. The blending module 305 is described with reference to FIG. 7.

According to embodiments of the present disclosure, the training module 307 may be implemented after the blending module 305 for the training of the AI model 211. The training module 307 may be configured to train the AI model 211 based on the blended grid pattern noisy image, at least one grid pattern noise sample extracted using the grid pattern extraction module 303, and at least one clean ground truth image such that the clean ground truth image may be a noise-free image. According to embodiments of the present disclosure, the training module 307 may train the AI model 211 such that the trained AI model may generate a denoised image corresponding to a sample input image such that a quality score of the denoised image may be above a predetermined threshold associated with a desired image quality.

According to embodiments of the present disclosure, the denoising module 309 may be configured to generate a grid pattern-free image by eliminating the input grid pattern noise from the captured image using the trained AI model 211 as described below in the forthcoming paragraphs. Further, the plurality of modules 213 are described with reference to subsequent figures of the present disclosure.

FIG. 4 is a block diagram 400 depicting an operational flow of the grid pattern detection module 301 and grid pattern extraction module 303, according to the embodiments of the present disclosure.

According to embodiments of the present disclosure, the grid pattern detection module 301 may be triggered when the image with grid pattern noise 311 is captured. Initially, the grid pattern detection module 301 may determine the Fourier magnitude spectrum map of the at least one color channel of RGB image data of the captured image.

For the determination, the grid pattern detection module 301, at operation 401, may obtain at least one single two-dimensional (2D) channel (e.g. the red (R) channel, the green (G) channel, or the blue (B)) of the image with grid pattern noise 311 and determine a Fourier Transform using a predetermined technique. In an embodiment, a 2D DFT of the at least one 2D channel may be determined using a Fast Fourier Transform (FFT) technique to generate a 2D DFT map, which may be represented as FFT(X), where X is the input channel. At each location in FFT(X), a complex value representing the spectral power for specific frequencies of the image may be stored.

The grid pattern detection module 301, at operation 403, may determine the Fourier magnitude spectrum map of at least one 2D channel. In an embodiment, from the determined complex valued FFT(X), a 2D magnitude spectrum map may be determined, which may be represented as Mag(FFT(X)). That is, the magnitude of complex-valued DFT for each location in the DFT map may be determined to obtain a real-valued magnitude spectrum map.

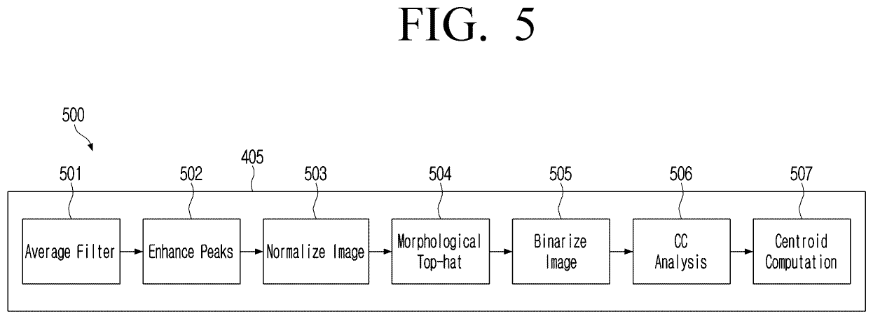

The grid pattern detection module 301, at operation 405, may determine the location at which a plurality of peaks are located in the magnitude spectrum map. In an embodiment, locations corresponding to the plurality of peaks may be stored as a vector of (x, y) values. In an embodiment, image processing techniques may be used to determine the location of the plurality of peaks, as described below with reference to FIG. 5.

FIG. 5 is a block diagram 500 depicting an operational flow for determining the plurality of peaks, according to embodiments of the present disclosure. As shown in FIG. 5, at operation 501, the magnitude spectrum map may be smoothened using an average filter sub-module that may convolve the magnitude spectrum map with a smoothing convolutional kernel. In an example, the magnitude spectrum map may be smoothened by an averaging filter kernel of 15×15 pixel neighborhood or any suitable neighborhood of the captured image 311. However, the present disclosure is not limited in this regard.

At operation 502, the smoothened magnitude spectrum map may be divided by an average of a larger pixel neighborhood than the smoothing kernel neighborhood to enhance the plurality of peaks and suppress relatively uniform regions within the smoothened magnitude spectrum map.

At operation 503, the magnitude spectrum map with the enhanced plurality of peaks may be normalized to a redefined range. For example, the magnitude spectrum map with enhanced plurality of peaks may be normalized to the [0, 1] range by subtracting the minimum value of the magnitude spectrum map and dividing by the range so that all values are constrained to the [0, 1] range.

At operation 504, the enhanced plurality of peaks may be brightened in the normalized magnitude spectrum map using a morphological top-hat technique. The morphological top-hat technique may refer to a digital image processing technique used to enhance features in an image, such as, but not limited to, small objects or bright details on a darker background. In the embodiments of the present disclosure, morphological top-hat technique may be used to brighten the plurality of peaks to facilitate detection after performing a binarization operation.

At operation 505, a thresholding technique may be applied on the normalized magnitude spectrum map with enhanced and brightened plurality of peaks to extract regions containing the plurality of peaks. Further, the extracted regions containing the plurality of peaks may be binarized to create a mask, such that in the binarized magnitude spectrum map, the plurality of peaks are marked as one (1) (e.g., a maximum normalized value), while the rest is set to zero (0) (e.g., a minimum normalized value).

At operation 506, a number of isolated regions and corresponding properties in the mask may be determined based on connected component (CC) analysis. The CC analysis may refer to an image processing technique that may identify and/or group pixels in an image that may be connected to each other. According to embodiments of the present disclosure, since the grid pattern noise may be periodic and high frequency, the plurality of peaks in the magnitude spectrum map may be separated such that the binary mask contains a plurality of peaks in a large area of the magnitude spectrum map.

At operation 507, the centroid of each region of the plurality of peaks within the magnitude spectrum map may be determined to detect the plurality of peaks and obtain the exact location of the plurality of peaks corresponding to grid pattern noise.

Referring back to FIG. 4, the grid pattern detection module 301, at operation 407, may detect the occurrence of periodic peaks in the Fourier magnitude spectrum map. According to embodiments of the present disclosure, upon detection of the plurality of peaks, the occurrence of periodic peaks may be detected based on a periodicity of the plurality of peaks in the Fourier magnitude spectrum map.

In an embodiment, the periodicity of the plurality of peaks may be determined based on the Fourier transform property according to which spectral peaks of periodic signals occur in pairs and have second or third order harmonics. Therefore, for periodic peaks, multiple regularly spaced peaks may appear in the spectrum map, unlike when the peaks are non-periodic. According to embodiments of the present disclosure, the periodicity of the plurality of peaks may refer to the set of adjacent peaks separated by a common distance.

According to embodiments of the present disclosure, for determining the periodicity of the plurality of peaks, a distance between a set of adjacent peaks may be determined based on the location of the periodic peaks in the Fourier magnitude spectrum map. In an embodiment, if two distances differ by a small amount (e.g., ten (10) pixels) then the two distances may be considered as the same distance. Further, for each distinct distance, the corresponding frequency of adjacent peaks may be determined. If the frequency is greater than two (2), such a set of adjacent peaks may be considered as periodic peaks. Alternatively, if the frequency is less than two (2), such a set of adjacent peaks may be considered as non-periodic, and, hence, may be discarded.

The presence of grid pattern noise may be detected when the distance between the set of adjacent peaks considered periodic exceeds a predetermined threshold associated with the determination of the grid pattern. The grid pattern detection module 301, at operation 409, may transmit the location of the periodic peaks and the periodicity information to the grid pattern extraction module 303.

According to embodiments of the present disclosure, the grid pattern extraction module 303, at operation 411, may extract spectral information corresponding to grid pattern noise based on the location of the periodic peaks and periodicity information. In an embodiment, a complex valued DFT map of the at least one color channel of RGB image data along with the periodicity and location of the periodic peaks may be obtained and the DFT values corresponding to the grid pattern noise may be extracted based on the location of the periodic peaks and periodicity information. In an embodiment, DFT values at peak locations with specified periods may be extracted to create a new DFT map of a same size, which may be represented as FFT(X′).

The grid pattern extraction module 303, at operation 413, may determine an inverse Fourier magnitude spectrum map corresponding to the Fourier magnitude spectrum map of at least one color channel of the RGB image data of the captured image 311. In an embodiment, the DFT map containing the grid-pattern specific spectral energies may be used to compute an inverse DFT (IDFT) using the inverse FFT technique (e.g., IFFT(X′), to obtain the spatial domain grid noise pattern.

At operation 415, the grid pattern extraction module 303 may compute the magnitude of the IDFT map (e.g., Mag(IFFT(X′))) to get an un-normalized 2D grid pattern. At operation 417, the grid pattern extraction module 303 may apply a normalization function on the un-normalized 2D grid pattern to remove any biases and obtain the extracted 2D grid patterns corresponding to the grid pattern noise 419.

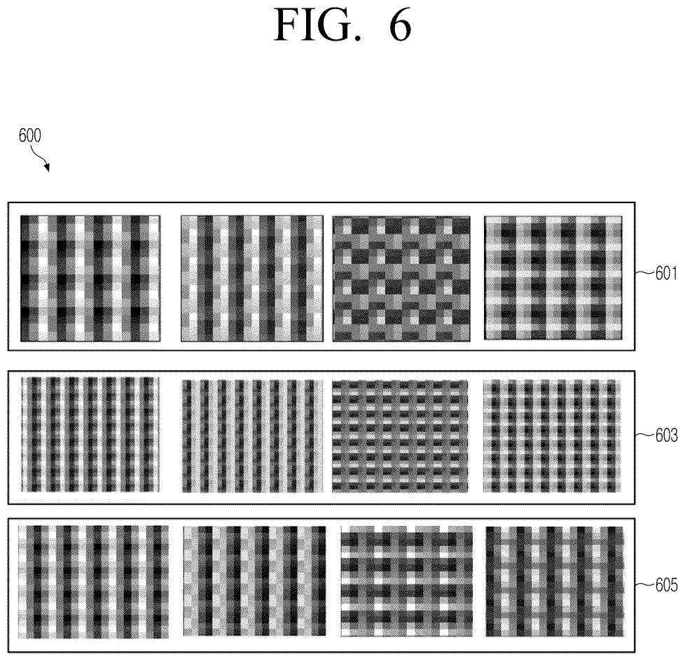

According to embodiments of the present disclosure, by following the above-described techniques for grid pattern detection and/or extraction, unique noise patterns may be extracted from limited validation images as depicted in FIG. 6.

FIG. 6 is a pictorial diagram 600 depicting exemplary visualization of extracted patterns, according to embodiments of the present disclosure. As shown in FIG. 6, block 601 illustrates exemplary grid patterns corresponding to the blue (B) color channel, block 603 illustrates exemplary grid patterns corresponding to the green (G) color channel, and block 605 illustrates exemplary grid patterns corresponding to red (R) color channel. However, the present disclosure is not limited in this regard, and various other grid patterns may be applied to the color channels without departing from the scope of the present disclosure.

According to embodiments of the present disclosure, upon extraction of the grid pattern noise 419, a grid pattern free image 313 corresponding to the captured image 311 may be generated by eliminating the extracted grid pattern noise from the captured image using a trained AI model.

According to embodiments of the present disclosure, during the training, a first set of clean images and a first set of sample grid pattern noise may be obtained, such that the first set of clean images may correspond to a predetermined set of grid pattern noise free images. Thereafter, the blended grid pattern noisy image may be generated by applying an optimized blending factor to a subset of the first set of clean images and at least one grid pattern noise sample from the first set of sample grid pattern noise. The determination of the optimized blending factor is described below with reference to FIG. 7.

FIG. 7 is a block diagram 700 depicting an operational flow of the blending module 305, for determination of the optimized blending factor, according to embodiments of the present disclosure.

According to embodiments of the present disclosure, the blending module 305 may synthetically generate a training dataset for the AI model 211 training. For example, the blending module 305 may generate the training dataset by blending extracted grid pattern noise with a subset of the first set of clean images. According to embodiments of the present disclosure, the blending module 305 may be configured to determine the optimized blending factor that may be used for blending the grid pattern noise with the training dataset in order to produce the best possible removal of the grid pattern after complete training of the AI model 211 with the dataset synthetically created by blending the grid pattern noise images with clean images the first set of clean images. Operations performed by the blending module 305 are described below.

According to embodiments of the present disclosure, a blending factor may refer to a mixing ratio that may determine what fraction of noise has to be blended with training images to simulate a realistic grid pattern corrupted training dataset used for training the AI model 211. However, an incorrect choice of the blending factor may lead to poor quality removal of grid pattern noise, color noise, and other similar kinds of noise. Hence, optimization of the blending factor value that varies with a given training dataset may be critical.

At operation 701, an initial blending factor α may be determined based on a subset of the first set of clean images and at least one grid pattern noise sample from the first set of sample grid pattern noise using an intelligent parameter optimization (IPO) technique. In an embodiment, the subset of the first set of clean images may be a small subset, for example, 20% of the first set of clean images. In an embodiment, at least one grid pattern noise sample may be randomly selected from the first set of sample grid pattern noise.

At operation 703, the initial blending factor α may be applied to the subset of the first set of clean images and the at least one grid pattern noise sample from the first set of sample grid pattern noise to obtain an initial blended grid pattern noisy image.

According to embodiments of the present disclosure, blended grid pattern noisy images may be synthetically created from the subset of the first set of clean images. By blending the subset of the first set of clean images with the grid pattern noise images using the optimized blending factor. For each clean image, the at least one grid pattern noise sample may be randomly chosen from the first set of sample grid pattern noise. The grid pattern may be replicated for a predefined number of times and stacked along a depth dimension. In addition, operation 703 may ensure that no color artifacts are introduced as all color channels may get the same grid noise pattern. Thereafter, the clean image and the at least one grid pattern noise sample may be normalized to the same range followed by a weighted linear combination to obtain the blended grid pattern noisy image. The optimized blending factor may enable the determination of the weights given to grid pattern noise with respect to the clean image.

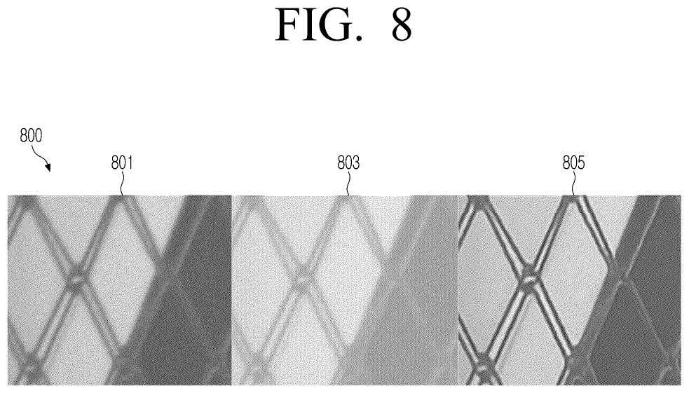

At operation 705, the AI model 211 may be trained based on the initial blended grid pattern noisy image, the at least one grid pattern noise sample, and at least one clean ground truth image such that the trained AI model may generate an initial denoised image corresponding to the sample input image. According to embodiments of the present disclosure, the at least one clean ground truth image may be a noise free image as depicted in FIG. 8.

FIG. 8 is a pictorial diagram 800 depicting an exemplary clean image, an exemplary blended grid pattern noisy image, and an exemplary clean ground truth image, according to embodiments of the present disclosure. Referring to FIG. 8, block 801 depicts an exemplary clean image from the first set of clean images. As shown in FIG. 8, the exemplary clean image 801 may be a grid pattern noise free image. However, the exemplary clean image may have other kinds of noise such as, but not limited to, shot noise, chroma noise, noise due to analog to digital conversion, quantization noise, or the like.

As shown in FIG. 8, block 803 depicts an exemplary blended grid pattern noisy image. The exemplary blended grid pattern noisy image 803 may explicitly contain the grid pattern noise in addition to the noises in the exemplary clean image.

Continuing to refer to FIG. 7, block 805 depicts an exemplary clean ground truth image. The exemplary clean ground truth image 805 may not contain any kind of noise. According to embodiments, the clean ground truth image 805 may refer to an image that has been contrast, brightness, and saturation enhanced, color corrected, tone-mapping applied, sharpened, and/or additional post-processing prior to being provided to the user.

Referring back to FIG. 7, at operation 707, an initial quality score of the initial denoised image may be determined using an AI-based image quality assessment technique. The initial quality score may be compared with the predetermined threshold associated with a desired image quality. In an example, a modified version of a neural image assessment (NIMA) model may be used for image quality assessment.

In an exemplary embodiment, the NIMA model may be modified to predict whether or not a grid pattern is present in an image by using input image tiles at actual resolution with suitable padding, replacing a last fully connected (FC) layer with a sigmoid layer, using binary cross-entropy loss instead of earth mover's distance (EMD) to predict two (2) classes (e.g., grid pattern present, grid pattern absent). The NIMA model may be further modified by fine-tuning the new last layer along with other layers with suitable learning rate multipliers, computing an F-score for an image based on tile predictions as image quality assessment score for the image, and computing average F-score for all validation images as the image quality assessment score of the model for a validation set.

In an embodiment, when the initial quality score is below the predetermined threshold, the initial blending factor may be optimized using the IPO technique based on the initial quality score to obtain the optimized blending factor α*.

According to embodiments of the present disclosure, the IPO technique may be used to determine the optimized blending factor in one or more iterations of operations 702 through 707. In each iteration, the blending factor computed in the previous iteration may be optimized, the blended grid pattern noisy image may be recomputed, the AI model 211 may be retrained, and the image quality score may be re-determined until the desired image quality score may be achieved and/or a predefined maximum number of iterations may be exceeded.

At operation 709, the training dataset for the AI model 211 training may be generated by blending the first set of clean images with the optimized blending factor α*. The training dataset may be used to train the AI model 211 by the training module 307.

According to embodiments of the present disclosure, the training module 307 may be configured to use the training dataset for training the model based on the blended grid pattern noisy image, the at least one grid pattern noise sample, and at least one clean ground truth image, such that the trained AI model 211 may generate the denoised image corresponding to the sample input image.

According to embodiments of the present disclosure, the AI model 211 may be further automatically trained to remove other types of noises including, but not limited to Poisson-Gaussian noise, additive white Gaussian noise, or the like, such that a fully denoised image may be produced by the trained AI model 211. According to embodiments of the present disclosure, the trained AI model 211 may be used by the denoising module 309 to generate the grid pattern free image 313 from the captured image 311.

According to embodiments of the present disclosure, the denoising module 309 may be implemented after the grid pattern extraction module 303 in the operational pipeline for detecting and/or eliminating grid pattern noise from the captured image 311 captured using camera 209. The denoising module 309 may be configured to generate the grid pattern free image 313 by eliminating the grid pattern noise extracted from the captured image 311 by the grid pattern extraction module 303 using the trained AI model 211.

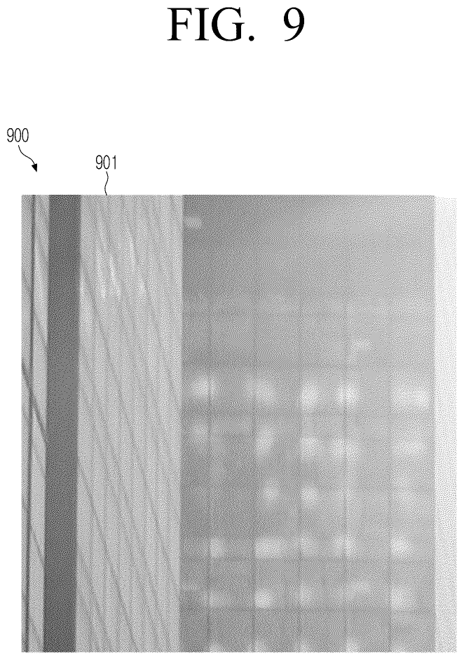

FIG. 9 is a pictorial diagram 900 depicting an exemplary grid pattern free image generated by the trained AI model 211, according to embodiments of the present disclosure. Referring to FIG. 9, block 901 depicts a grid pattern free image generated by denoising module 309 by eliminating the grid pattern noise from the image 111 using the trained AI model 211.

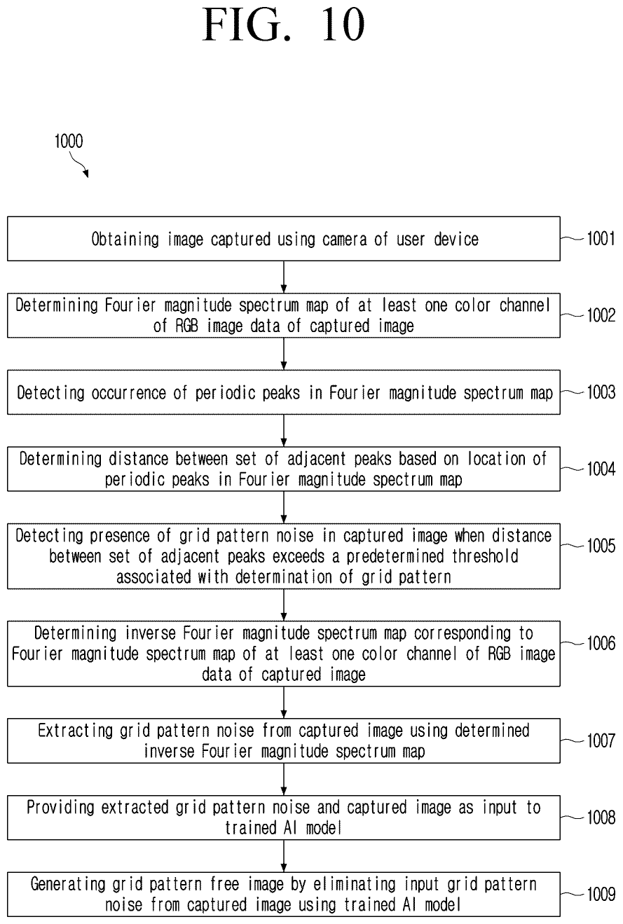

FIG. 10 is a flow diagram depicting a method 1000 for detecting the grid pattern in the captured image 311 captured using the user device 201, according to embodiments of the present disclosure. The method 1000 includes a series of operations 1001 through 1009 executed by one or more components of the user device 201, such as, but not limited to the processor 205.

At operation 1001, the processor 205 may obtain the captured image 311 captured using the camera 209 of the user device 201.

At operation 1002, the processor 205 may determine the Fourier magnitude spectrum map of the at least one color channel of RGB image data of the captured image 311.

At operation 1003, the processor 205 may detect the occurrence of periodic peaks in the Fourier magnitude spectrum map. In an embodiment, for detecting the occurrence of the periodic peaks, the processor 205 may be configured to detect the plurality of peaks in the Fourier magnitude spectrum map and to detect the occurrence of the periodic peaks based on a periodicity of the plurality of peaks in the Fourier magnitude spectrum map.

At operation 1004, the processor 205 may determine the distance between a set of adjacent peaks based on a location of the periodic peaks in the Fourier magnitude spectrum map.

At operation 1005, the processor 205 may detect the presence of grid pattern noise in the captured image when the distance between the set of adjacent peaks exceeds the predetermined threshold associated with the determination of grid pattern.

At operation 1006, the processor 205 may determine the inverse Fourier magnitude spectrum map corresponding to the Fourier magnitude spectrum map of the at least one color channel of the RGB image data of the captured image 311.

At operation 1007, the processor 205 may extract the grid pattern noise from the captured image using the determined inverse Fourier magnitude spectrum map.

At operation 1008, the processor 205 may provide the extracted grid pattern noise and the captured image 311 as input to the trained AI model 211.

At operation 1009, the processor 205 may generate the grid pattern free image 313 by eliminating the input grid pattern noise from the captured image using the trained AI model 211.

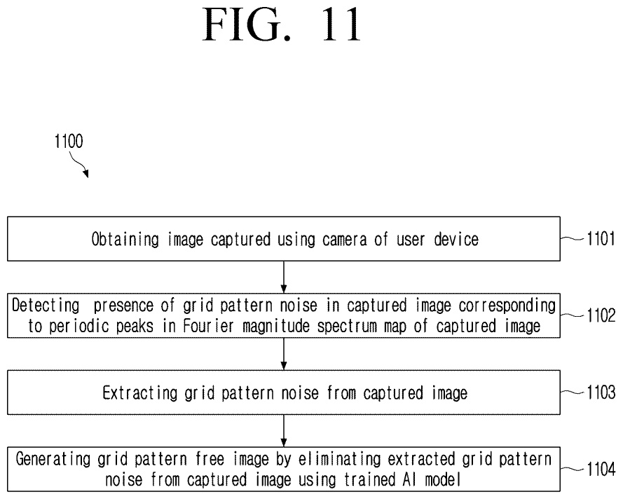

FIG. 11 is a flow diagram depicting a method 1100 for eliminating the grid pattern from the captured image 311 captured using the user device 201, according to embodiments of the present disclosure. The method 1100 includes a series of operations 1101 through 1104 executed by one or more components of the user device 201, such as, but not limited to the processor 205.

At operation 1101, the processor 205 may obtain the captured image 311 captured using the camera 209 of the user device 201.

At operation 1102, the processor 205 may detect the presence of grid pattern noise in the captured image 311 corresponding to periodic peaks in the Fourier magnitude spectrum map of the captured image 311.

At operation 1103, the processor 205 may extract the grid pattern noise from the captured image 311.

At operation 1104, the processor 205 may generate the grid pattern free image 313 by eliminating the extracted grid pattern noise from the captured image 311 using the AI model 211.

In an embodiment, the AI model may be trained by obtaining a first set of clean images and a first set of sample grid pattern noise such that the first set of clean images corresponds to a set of grid pattern noise free images, generating the blended grid pattern noisy image by applying an optimized blending factor to the subset of the first set of clean images and at least one grid pattern noise sample from the first set of sample grid pattern noise, and training the AI model based on the blended grid pattern noisy image, the at least one grid pattern noise sample, and at least one clean ground truth image, such that the trained AI model may generate a denoised image corresponding to a sample input image. In an embodiment, the clean ground truth image may be a noise free image, and the quality score of the denoised image may be above (e.g., exceed) a predetermined threshold associated with a desired image quality.

In an embodiment, the optimized blending factor may be obtained by applying an initial blending factor to the subset of the first set of clean images and the at least one grid pattern noise sample from the first set of sample grid pattern noise to obtain an initial blended grid pattern noisy image, followed by training the AI model based on the initial blended grid pattern noisy image, the at least one grid pattern noise sample and at least one clean ground truth image such that the trained AI model may generate an initial denoised image corresponding to the sample input image and determining an initial quality score of the initial denoised image, followed by comparing the initial quality score with the predetermined threshold and optimizing the initial blending factor to obtain the optimized blending factor when the initial quality score is below the predetermined threshold.

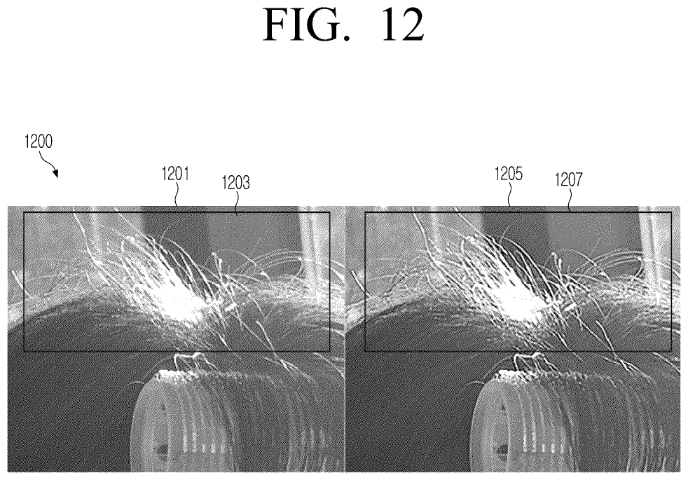

FIG. 12 is a pictorial diagram 1200 depicting a use case illustrating elimination of grid pattern from an image captured using the user device 201, according to embodiments of the present disclosure.

Referring to FIG. 12, the image 1201 depicts an exemplary image with grid pattern noise highlighted in box 1203. When the same image is captured using the user device 201, a grid pattern free image 1205 may be generated. As highlighted using the block 1207, the user device 201 may be enabled to generate the grid pattern free image 1205 by implementing the methods for detecting and/or eliminating grid patterns from captured images, according to embodiments of the present disclosure.

At least by virtue of the aforesaid, the present subject matter at least provides the following advantages.

The systems and methods described herein may improve overall visual experience on the user device by enhancing the image quality of the captured frames in high resolution captures. The methods described herein may be implemented with a software update of an existing application for image processing. Furthermore, the systems and methods described herein may not introduce a measurable extra latency and/or an increase in computation time or memory requirements. The methods described herein may be fully automated. The systems and methods described herein may provide a methodology to eliminate the noise without modifying and/or tuning the camera sensor hardware.

In the present disclosure, unless specifically stated otherwise, the use of the singular may include the plural, and the use of “or” may be interpreted as “and/or.” Furthermore, the use of the terms “including” and/or “having” may not be limiting (e.g., closed-ended). Any range described herein is to be understood to include the endpoints and all values between the endpoints. Features of the disclosed embodiments may be combined, rearranged, omitted, or the like, within the scope of the present disclosure to produce additional embodiments. Furthermore, certain features may sometimes be used to advantage without a corresponding use of other features.

While at least one exemplary embodiment has been presented in the foregoing detailed description, it is to be appreciated that a vast number of variations exist.

What is claimed is:

1. A method for detecting grid pattern noise in an image, the method comprising:
obtaining the image;
determining a spectrum map of at least one color channel of the image;
detecting an occurrence of periodic peaks in the spectrum map;
determining a distance between a set of adjacent peaks based on a location of the periodic peaks in the spectrum map;
detecting a presence of grid pattern noise in the image based on the distance; and
eliminating, based on the detecting of the presence of the grid pattern noise, the grid pattern noise from the image, resulting in a revised image.

2. The method of claim 1, wherein the detecting of the occurrence of the periodic peaks comprises:
detecting a plurality of peaks in the spectrum map; and
detecting the occurrence of the periodic peaks based on a periodicity of the plurality of peaks in the spectrum map.

3. The method of claim 2, wherein the detecting of the occurrence of the periodic peaks further comprises:
obtaining position information corresponding to the plurality of peaks in the spectrum map; and
detecting the occurrence of the periodic peaks based on the position information.

4. The method of claim 1, wherein the detecting of the occurrence of the periodic peaks comprises detecting a first peak and a second peak in the spectrum map,
wherein the determining of the distance between the set of adjacent peaks comprises:
obtaining a first position of the first peak and a second position of the second peak; and
determining the distance between the set of adjacent peaks based on the first position of the first peak and the second position of the second peak, and
wherein the detecting of the presence of the grid pattern noise comprises detecting the presence of the grid pattern noise in the image based on the distance exceeding a predetermined threshold.

5. The method of claim 1, wherein the detecting of the occurrence of the periodic peaks comprises:
detecting a first peak, a second peak, and a third peak in the spectrum map;
obtaining a first position of the first peak, a second position of the second peak, and a third position of the third peak;
obtaining a first distance between the first position of the first peak and the second position of the second peak;
obtaining a second distance between the second position of the second peak and the third position of the third peak;
obtaining a difference between the first distance and the second distance; and
identifying, based on the difference being smaller than a predetermined value, the occurrence of the periodic peaks in the spectrum map.

6. The method of claim 1, wherein the obtaining of the image comprises:
obtaining the image from a camera of a user device.

7. The method of claim 1, wherein the spectrum map comprises a Fourier magnitude spectrum map.

8. The method of claim 1, wherein the image comprises red, green, and blue (RGB) image data, and
wherein the RGB image data comprises the at least one color channel.

9. The method of claim 8, further comprising:
determining an inverse spectrum map corresponding to the spectrum map of the at least one color channel; and
extracting the grid pattern noise from the image using the inverse spectrum map.

10. The method of claim 3, further comprising:
providing the grid pattern noise and the image as input to a trained artificial intelligence (AI) model; and
generating a grid pattern free image by eliminating the grid pattern noise from the image using the trained AI model.

11. An electronic apparatus for detecting grid pattern noise in an image, the electronic apparatus comprising:
one or more processors comprising processing circuitry; and
memory storing instructions,
wherein the instructions, when executed by the one or more processors individually or collectively, cause the electronic apparatus to:
obtain the image;
determine a spectrum map of at least one color channel of the image;
detect an occurrence of periodic peaks in the spectrum map;
determine a distance between a set of adjacent peaks based on a location of the periodic peaks in the spectrum map;
detect a presence of grid pattern noise in the image based on the distance; and
eliminate, based on the detection of the presence of the grid pattern noise, the grid pattern noise from the image, resulting in a revised image.

12. The electronic apparatus of claim 11, wherein the instructions, when executed by the one or more processors individually or collectively, further cause the electronic apparatus to:
detect a plurality of peaks in the spectrum map; and
detect the occurrence of the periodic peaks based on a periodicity of the plurality of peaks in the spectrum map.

13. The electronic apparatus of claim 12, wherein the instructions, when executed by the one or more processors individually or collectively, further cause the electronic apparatus to:
obtain position information corresponding to the plurality of peaks in the spectrum map; and
detect the occurrence of the periodic peaks based on the position information.

14. The electronic apparatus of claim 11, wherein the instructions, when executed by the one or more processors individually or collectively, further cause the electronic apparatus to:
detect a first peak and a second peak in the spectrum map;
obtain a first position of the first peak and a second position of the second peak;
determine the distance between the set of adjacent peaks based on the first position of the first peak and the second position of the second peak; and
detect, based on the distance exceeding a predetermined threshold, the presence of grid pattern noise in the image.

15. The electronic apparatus of claim 11, wherein the instructions, when executed by the one or more processors individually or collectively, further cause the electronic apparatus to:
detect a first peak, a second peak, and a third peak in the spectrum map;
obtain a first position of the first peak, a second position of the second peak, and a third position of the third peak;
obtain a first distance between the first position of the first peak and the second position of the second peak;
obtain a second distance between the second position of the second peak and the third position of the third peak;
obtain a difference between the first distance and the second distance; and
identify, based on the difference being smaller than a predetermined value, the occurrence of the periodic peaks in the spectrum map.

16. The electronic apparatus of claim 11, wherein the spectrum map comprises a Fourier magnitude spectrum map.

17. The electronic apparatus of claim 11, wherein the image comprises red, green, and blue (RGB) image data, and
wherein the RGB image data comprises the at least one color channel.

18. The electronic apparatus of claim 11, wherein the instructions, when executed by the one or more processors individually or collectively, further cause the electronic apparatus to:
determine an inverse spectrum map corresponding to the spectrum map of the at least one color channel; and
extract the grid pattern noise from the image using the inverse spectrum map.

19. The electronic apparatus of claim 13, wherein the instructions, when executed by the one or more processors individually or collectively, further cause the electronic apparatus to:
provide the grid pattern noise and the image as input to a trained artificial intelligence (AI) model; and
generate a grid pattern free image by eliminating the grid pattern noise from the image using the trained AI model.
